(19) United States
(12) Patent Application Publication
(10) Pub. No.: US 2002/0039545 A1
(43) Pub. Date: Apr. 4, 2002

(54) Multi-well plate cover and assembly adapted for mechanical manipulation

(76) Inventors: John P. Hall, Raleigh, NC (US); Andrew P. Muser, Durham, NC (US); Kenneth W. Whitley, Raleigh, NC (US)

Correspondence Address: BECTON, DICKINSON AND COMPANY, 1 BECTON DRIVE, FRANKLIN LAKES, NJ, 07417-1880, US

(21) Appl. No.: 09/920,496

(22) Filed: Aug. 1, 2001

Related U.S. Application Data
(60) Provisional application No. 60/236,391, filed on Sep. 29, 2000.

(51) Int. Cl. B01L 3/00

(52) U.S. Cl. 422/102; 422/99

(57) ABSTRACT

A multi-well plate cover and assembly comprises a lid and gasket. The lid has integral spring means for uniformly applying force to the surface of a gasket to seal a multi-well plate. The lid has members for mechanical manipulation and for attachment to a multi-well plate.

### BACKGROUND OF THE INVENTION

1. Field of the Invention

The present invention relates to an improved multi-well plate cover of the type typically used in the laboratory science fields of biology, chemistry and pharmaceutical research to cover multi-well plates. More specifically, the improved cover and assembly is adapted for improved sealing function and for mechanical manipulation by robotic or other mechanical means.

2. Description of the Related Art

In the areas biological, chemical and pharmaceutical research, it is a common practice to utilize multi-well plates for storage and analytical purposes. Generally these plates, normally constructed of plastic materials, have a 3″×5″ footprint and contain from 12 to 1536 wells organized in rows. The individual well geometry of a multi-well plate can vary between round and square, with contained volumes from 1 microliter to 200 microliters. The plates are particularly suited to the use of laboratory automation for the handling, storage and assay of chemical and biological entities.

The multi-well plates, being liquid-filled and subject to storage, have a number of lidding options available to the user. The simplest form of cover is a molded plastic lid that loosely fits over the multi-well plate. For some researchers this may provide an adequate seal, but other researchers may require a more robust cover that provides for protection from both the ingress and egress of materials into the individual wells. The nature of ingression can include the absorbence of material such as water in the presence of DMSO, a preferred storage solvent with a hygroscopic nature, and transfer of materials between wells. Egression can include the loss of volume due to evaporation or sublimation.

Another form of lidding is that of an adhesive seal type cover such as Costar® Thermowell™ sealers (Catalog No. 6570). An adhesive seal is approximately 3″×5″ and consists of a substrate material such as a thin foil or plastic film to which an adhesive has been applied. These seals can be applied by mechanical or manual means. The adhesive seal is removed by hand as there is no mechanical device for removal. The adhesive seal provides superior sealing properties in contrast to the plastic lid but has a number of deficiencies: (1) it can only be used once; (2) its adhesive can come in contact with the stored entity; and (3) during removal if any of the stored entity is on the inner surface of the seal, it may be problematic for worker safety. Additionally, if repeated seals are applied to the same multi-well plate the adhesive tends to build up, compromising the seals of successive applications.

Yet another form of lidding is the use of a heat-sealed cover such as the Abgene Easy Peel Polypropylene Sealing Film (Catalog No. AB-0745). A heat-sealed cover is 3″×5″ and consists of a substrate material such as polypropylene film. Most of the multi-well plates used for storage are polypropylene. With the application of heat and pressure by means of an Abgene Combi Thermal Sealer, the heat-sealed cover can be bonded to the polypropylene multi-well plate on the plate's upper surface. This seal is in essence a molecular bond cause by the melting of the polypropylene of the respective entities. As such, the heat seal cover sets the standard for multi-well plate sealing in terms of for protection from both the ingress and egress of materials into the individual wells. It can be applied by manual and mechanical means such as the Abgene 1000, a semi-automatic applicator that uses roll stock of the Abgene Easy Peel Sealing Film. However, there is no mechanical device for the removal of heat-sealed covers. Heat-sealed covers cannot be reused. Each time a heat-sealed cover is attached to the plate there can be distortion on the standoffs of the individual wells, plus polypropylene remnants, affecting the quality of future seals on the same plate.

Examples of mechanical coverage of multi-well plates are disclosed in U.S. Pat. No. 5,342,581 entitled “Apparatus for Preventing Cross Contamination of Multi-Well Test Plates”, issued Aug. 30, 1994, in the name of Sanadi; U.S. Pat. No. 5,516,490 entitled “Apparatus for Preventing Cross Contamination of Multi-Well Test Plates”, issued May 14, 1996, in the name of Sanadi; and U.S. Pat. No. 5,741,463 entitled “Apparatus for Preventing Cross Contamination of Multi-Well Test Plates”, issued Apr. 21, 1998, in the name of Sanadi; the disclosures of which are incorporated herein by reference.

Another example of mechanical coverage of multi-well plates is disclosed in a brochure entitled “SealTite Microplate Cover” from TekCel Corporation, Martinsville, N.J. Additional information on the “SealTite Microplate Cover” can be found on the WWW site “www.tekcel.com/sealtite.htm”, Copyright ©1998 TekCel Corporation.

### SUMMARY OF THE INVENTION

The subject invention is directed toward the repeated effective sealing and unsealing of multi-well plates utilizing mechanical manipulation. As noted above, there are a number of approaches to sealing multi-well plates. In the adhesive and thermal bonding approaches, a sealing mechanism is used to bond (either thermally or with an adhesive) a film over the wells of a multi-well plate to create an air and fluid barrier. While adequate for a single bonding instance, film approaches do not lend themselves to the requirement to access the multi-well plate multiple times in automation-based plate handling systems.

In the mechanically-based lid systems referenced above, the art describes the use of resilient materials which are pressed against the upper surface of the multi-well plate. These approaches also employ lids with clamps to secure the resilient material against the upper surface of the multi-well plate. An important requirement for this type of sealing is the ability to apply a normal force to the resilient material in a uniform manner.

In the invention described herein, the source of the compressive force is the lid itself by means of a curvilinear section of the lid which can provide a spring force when deformed, thereby applying a normal force more or less equally to the planar surface of a gasket which in turns seals the individual wells of a multi-well plate. Perpendicular side walls of the lid, which can be displaced laterally, are used to attach the lid to the multi-well plate. In this manner, a multi-well plate can be accessed multiple times by displacing the side walls and removing the cover.

The invention described herein is particularly adapted to work with robotic systems, which can use mechanical devices to secure the cover, apply it to a multi-well plate and remove the cover if desired.

### BRIEF DESCRIPTION OF THE DRAWINGS

FIG. 1 is a perspective view of a preferred embodiment of the invention showing a multi-well plate cover assembly designated 1, a lid 3, side walls 7 of said lid, notched tabs with locator holes 11 of said lid, stacking locators 13 of said lid, and the stacking lugs 17 of said lid.

FIG. 2 is a perspective end view of a portion of the cover assembly in FIG. 1 showing the lid 3 of said cover assembly and an uncompressed gasket 23 disposed on the underside of said lid 3.

FIG. 3 is a perspective view of said cover 1 of FIG. 1 positioned over a multi-well plate 5, with the side walls 7 extended in preparation for attachment to said multi-well plate.

FIG. 4 is a perspective view of the said cover 1 of FIG. 1 attached to a multi-well plate 5.

FIG. 5 is an end view of said cover 1, showing the curvilinear spring section 19 of the lid 3, the side walls 7 of said lid, the stacking lugs 17 of said lid, the notched tabs with locator holes 11 of said lid, the multi-well plate holders 15 of said lid and the uncompressed gasket 23.

FIG. 6 is a view similar to FIG. 5 in which the side walls 7 are laterally displaced outward.

FIG. 7 is a view similar to FIG. 6, in which the multi-well plate cover assembly 1 is pressed against a multi-well plate 5 to apply pressure to the compressed gasket 23 while the side walls 7 remain laterally displaced.

FIG. 8 is a view similar to FIG. 7, in which the multi-well plate cover assembly 1 is pressed against and extends over a multi-well plate 5 to apply pressure to the compressed gasket 23. Side walls 7 constrain the multi-well plate 5 by means of multi-well plate holders 15.

FIG. 9 is a perspective view showing means which could be used to perform the mechanical actions in attaching multi-well plate cover 1 to a multi-well plate 5. Means 31 is shown for holding multi-well plate 5 during covering and uncovering; means 29 is shown for vertical movement of multi-well plate cover assembly and compression of curvilinear spring section of multi-well plate cover 1; means 21 is shown for laterally displacing side walls 7; and means 27 is shown for gripping the multi-well plate cover 1.

FIG. 10 is a view similar to FIG. 9 showing means 21 laterally displacing side walls 7 of the lid 3 of the multi-well plate cover 1.

FIG. 11 is a view similar to FIG. 10 showing means 29 vertically placing the multi-well plate cover 1 on the multi-well plate 5 held by the means 31, while means 21 maintains the side walls 7 in a laterally displaced position.

FIG. 12 is a view similar to FIG. 11 showing means 21 releasing side walls 7 of the lid 3 of the multi-well plate cover 1, thereby securing said cover to the multi-well plate 5.

FIG. 13 is a view similar to FIG. 12 showing means 29 vertically moving the multi-well plate cover 1 attached to the multi-well plate 5.

FIG. 14 is a perspective view of several covers 1 in a stacked orientation utilizing stacking lugs 17 and stacking locators 13.

FIG. 15 is a perspective view of several covers 1 and multi-well plates 5 in a stacked orientation utilizing stacking lugs 17 and stacking locators 13.

### DETAILED DESCRIPTION

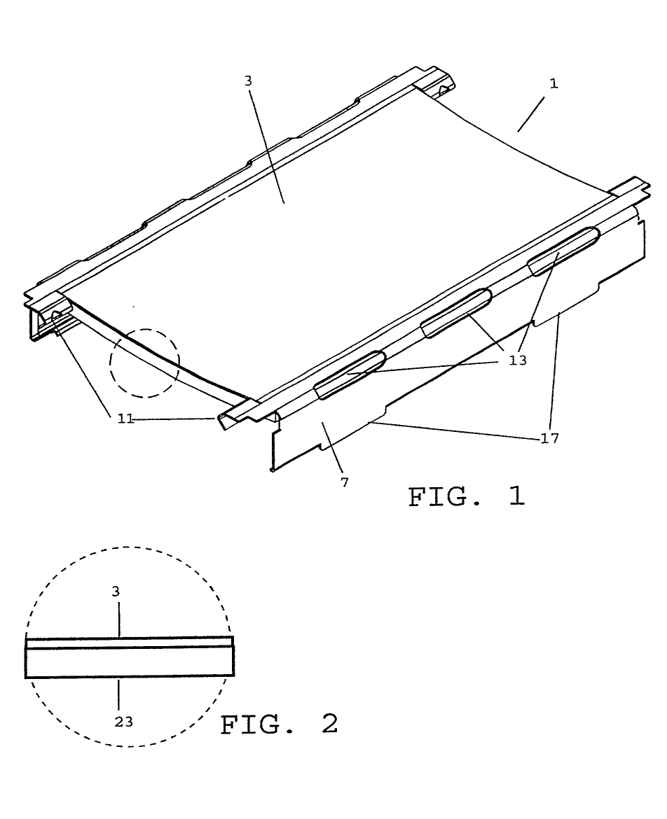

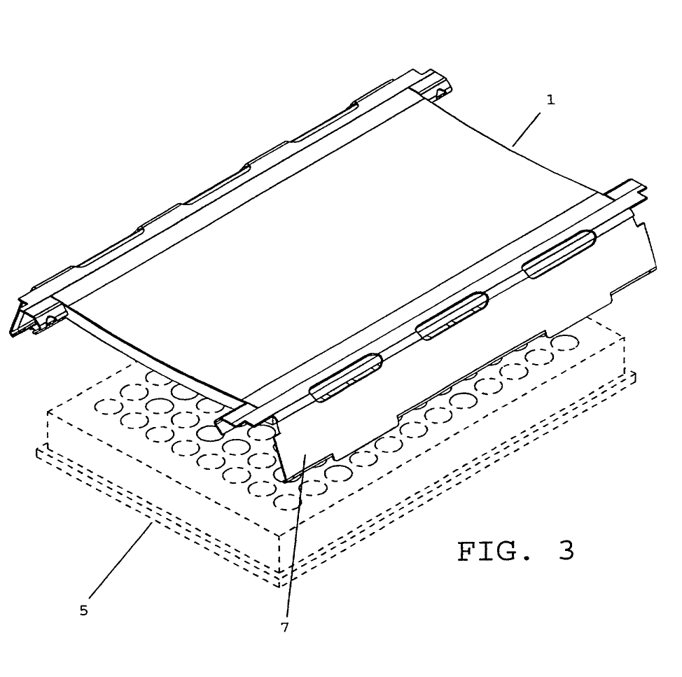

Referring now more particularly to the drawings, an assembly generally designated 1 as shown in FIG. 1 comprises a one-piece metal lid 3 which is fabricated by conventional metal fabrication techniques employing the cutting, stamping and/or bending of sheet metal. Suitable metals include steel, spring steel, stainless steel and stainless spring steel, preferably having a thickness between about 0.015″ and 0.024″. The metallic design provides a high degree of chemical resistance, especially to dimethyl sulfoxide, the solvent most commonly used in multi-well plate storage. Included as part of the lid are the side walls 7, integral to and formed at approximately 90 degrees to the top surface of said lid 3; the notched tabs with locator holes 11 integral with and extending from said lid 3; the stacking locators 13; and the stacking locator lugs 17. FIG. 2 shows a planar, uncompressed gasket 23 disposed on the convex side of the curvilinear section 19, covering said surface in sufficient area to fully engage the surface of a multi-well plate. The gasket 23 is preferably made from a low-durometer (Shore 15A or less) thermoplastic polymer or elastomer with a thickness of approximately 3/32″ or 0.100″. The gasket 23 is manufactured using standard injection molding or extrusion technology, and is preferably affixed by an adhesive to the bottom surface of the lid 3. A preferred gasket material is Synprene 5A manufactured by Polyone.

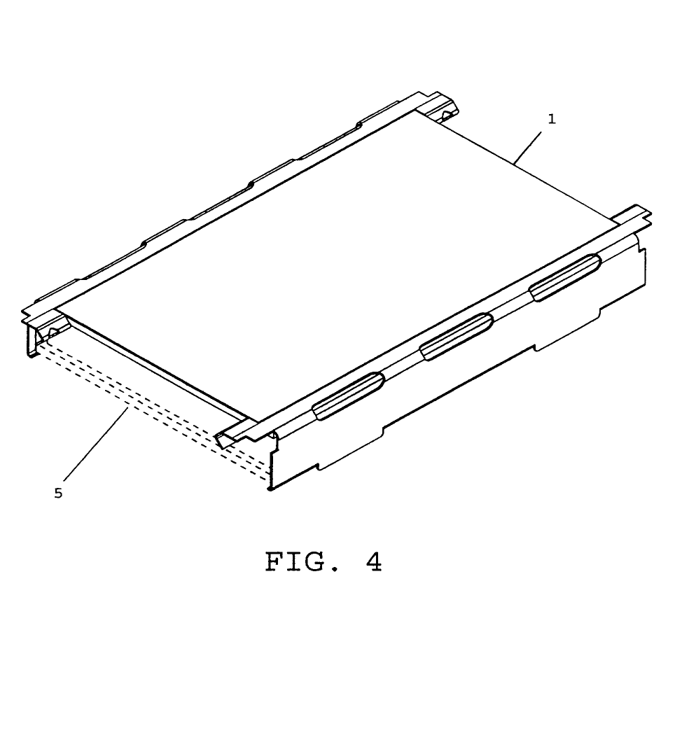

FIG. 3 shows the assembly 1, with the side walls 7 laterally displaced in preparation in for attachment to multi-well plate 5. The lateral displacement of the side walls 7 is accomplished by mechanical means which is not shown in FIG. 3 for illustrative purposes, but said means is shown in succeeding figures. Similarly, the means for gripping the cover assembly 1 and for placing said cover on the multi-well plate 5 are not shown in FIG. 3 but said means are shown in succeeding figures. FIG. 4 shows the multi-well plate cover 1 attached to a multi-well plate 5 in the normal storage mode.

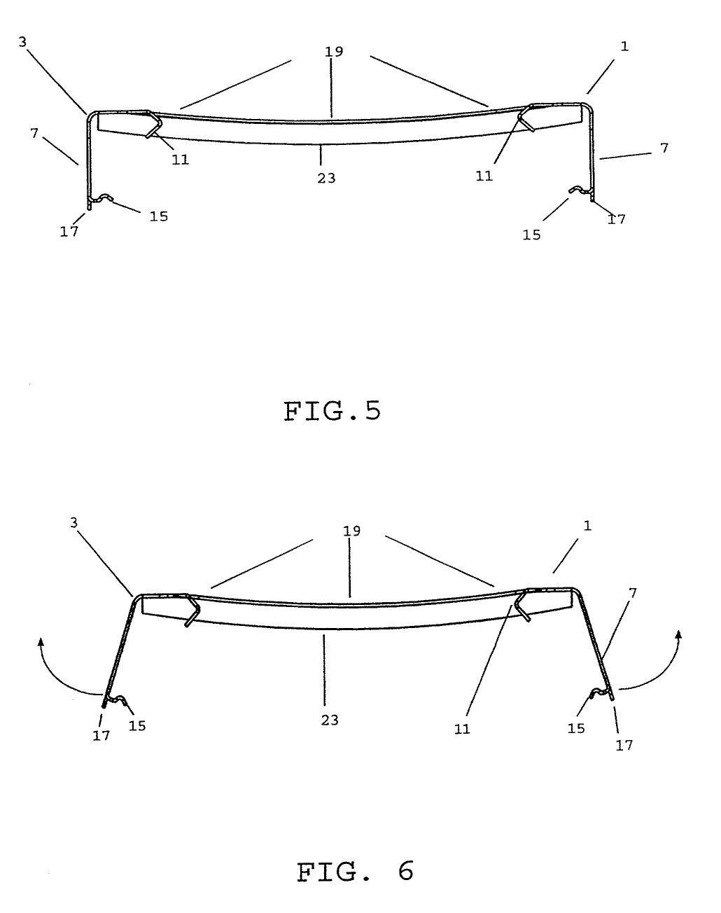

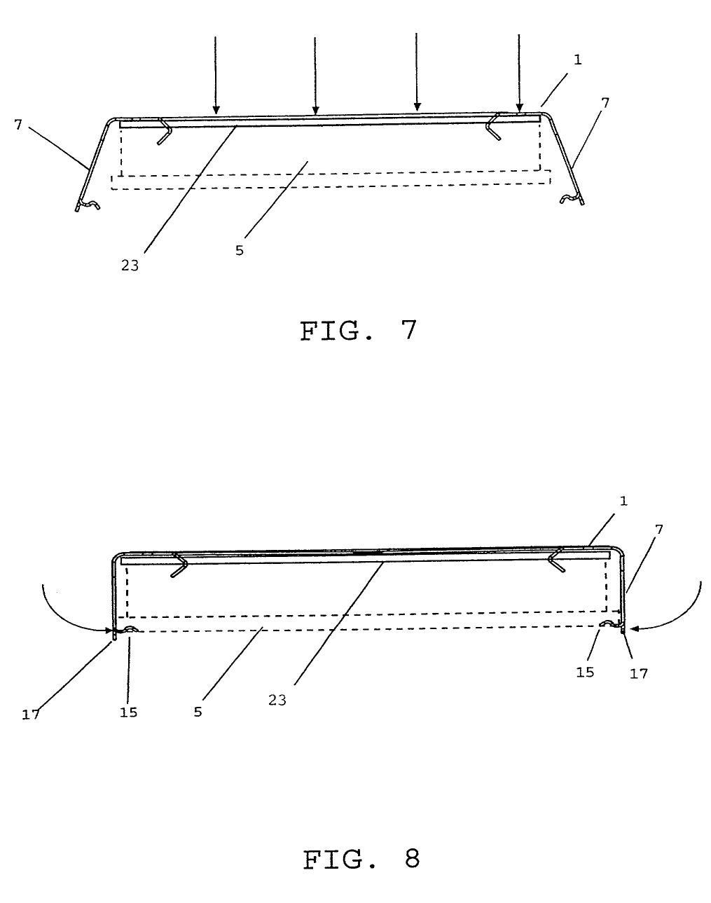

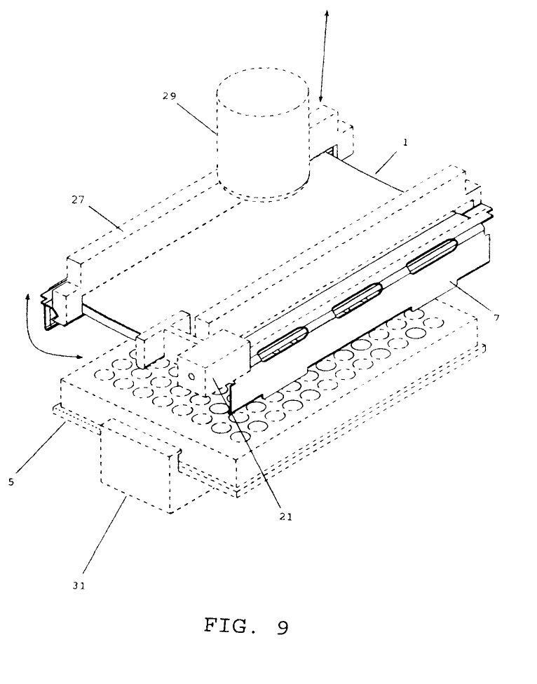

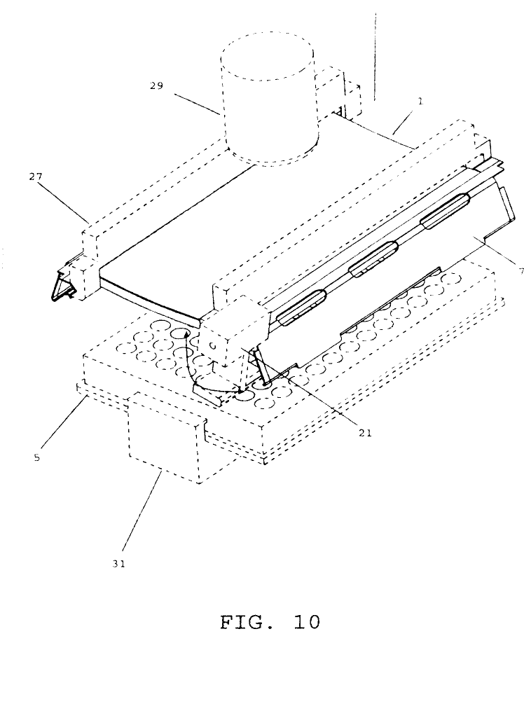

FIG. 5 is an end view of the multi-well plate cover and serves to illustrate the spring nature of said cover. FIG. 6 is also an end view of the multi-well plate cover and depicts the outward displacement of the side walls 7 of said cover in preparation for attachment to a multi-well plate. FIG. 7 shows a continuation of the process of attaching the multi-well plate cover to a multi-well plate in which said cover is vertically pressed onto said plate, causing the compression of the uncompressed gasket 23 onto the superior surface of said plate while the side walls 7 are outwardly extended. FIG. 8 shows a continuation of the process of attaching the multi-well plate cover to a multi-well plate in which said cover having been placed in contact with the superior surface of said plate has the side walls 7 released into their normal position in which multi-well plate holders 15 engage the skirt of the multi-well plate enabling the normal force of the of the curvilinear section 19 to maintain a compressive force on the compressed gasket.

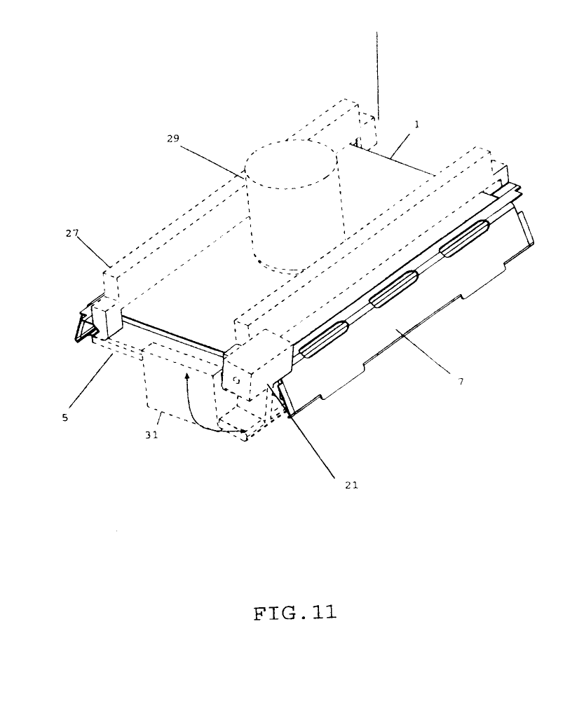

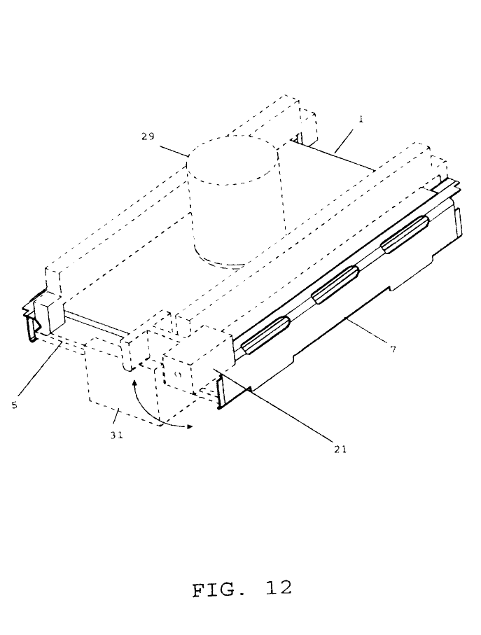

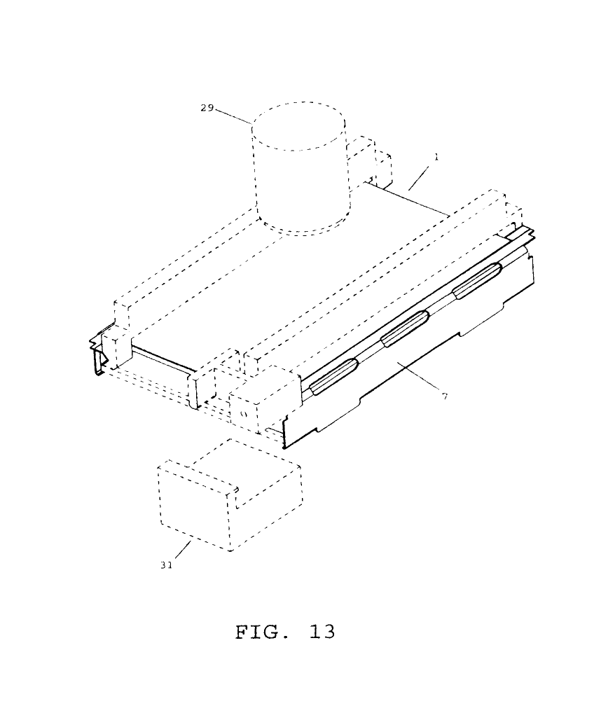

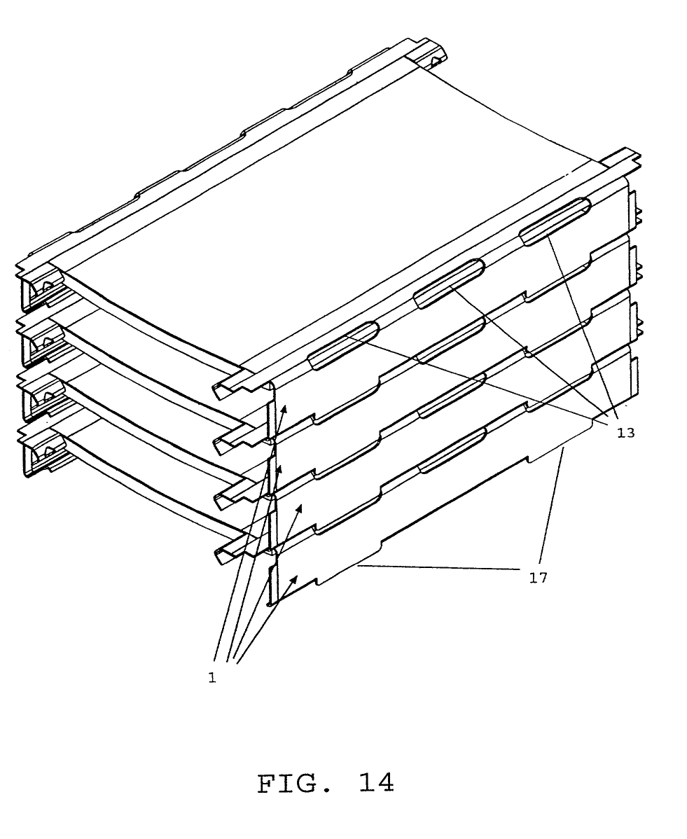

FIG. 9 through FIG. 13 show how a mechanical system such as an automated plate server would function with said cover 1. In FIG. 9, a multi-well plate 5 is shown held by means 31 in preparation for cover 1 attachment. Means 21 is shown for laterally displacing side walls 7, and means 27 is shown for gripping the multi-well plate cover 1. Means 29 provides for the vertical positioning of the cover assembly 1. FIG. 10 shows means 21 laterally displacing side walls 7 in preparation for cover 1 attachment. Continuing with the sequence, FIG. 11 shows the cover 1 placed on the surface of multi-well plate 5. This action also serves to compress the uncompressed gasket 23 shown in FIG. 6 to produce the compressed gasket 23 shown in FIG. 7. In FIG. 12, means 21 is shown releasing side walls 7 so the multi-well plate holders 15, as shown in FIG. 8, can engage and secure multi-well plate 5. FIG. 13, completing the sequence, shows the multi-well plate cover 1 attached to the multi-well plate 5 being moved by means 29. In FIG. 14, a stack of said covers is shown arranged vertically. The interaction of the stacking locators 13 and stacking lugs 17 provides stability and geometric alignment of the stack. Because said covers are normally used in automation based systems, a geometrically constrained stack is important to the pick and place robotic manipulation.

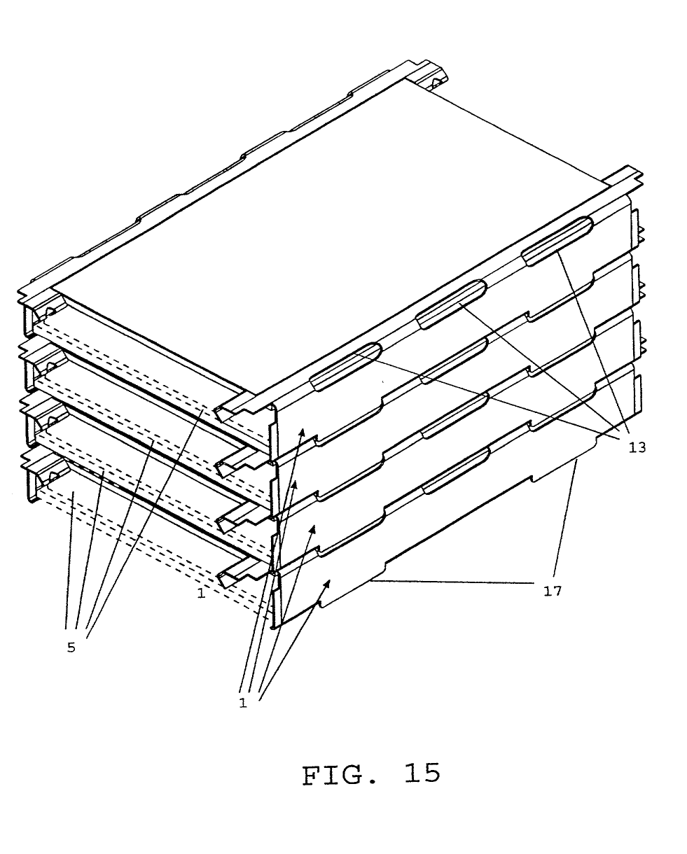

In FIG. 15, a stack of said covers attached to multi-well plates 9 is shown arranged vertically. The interaction of the stacking locators 13 and stacking lugs 17 provides stability and geometric alignment of the stack. The covered multi-well plate is normally stored in storage units that are robotic material handling systems. Geometrically constrained stacks are important to the pick and place robotic manipulation.

What is claimed is:

1. A cover for use in sealing and securing a multi-well plate and adapted for mechanical manipulation, said cover comprising:
(a) a lid dimensionally suited to covering a multi-well plate and providing a means for developing a normal spring force by means of a flexible curvilinear section of said lid;
(b) a plurality of projections and apertures integral to said cover plate;
(c) a uncompressed gasket disposed on one side of said lid; and
(d) two side walls of said lid approximately perpendicular to said curvilinear section of said lid, said side walls providing an attachment means for a multi-well plate, wherein said side walls, in the process of securing said multi-well plate, cause the deformation of said curvilinear section of said lid resulting in a normal spring force being applied to the gasket, compressing said gasket against the upper planar surface of the multi-well plate and effecting a seal.

2. The cover of claim 1, wherein approximately four of the projections function as notched tabs with locator holes for the gripping of said cover by mechanical methods.

3. The cover of claim 1, wherein at least two of the projections extending from and in the same planar relationship as the side walls of said lid function as stacking lugs.

4. The cover of claim 1, wherein at least two of the apertures formed in the approximately 90 degree bend between the side wall and curvilinear section serve as stacking locators.

5. The cover of claim 1, wherein the geometrical relationship of the stacking lugs and stacking locators is such as to align vertically one said cover upon another said cover in a stacked relationship.

6. The cover of claim 1, wherein each of the side walls has a formed element distal to the curvilinear section, which serves as a multi-well plate holder.

7. The cover of claim 1, wherein the uncompressed gasket material is formed from a thermoplastic polymer or elastomer having a durometer of Shore 15A or less and having low extractables in dimethyl sulfoxide.

8. The cover of claim 1, wherein the lid is formed from a material selected from the group consisting of steel, spring steel, stainless steel, and stainless spring steel, and has a thickness between about 0.015″ and 0.024″.

9. A multi-well plate sealed with a multi-well plate cover, comprising:
(a) a multi-well plate with an approximately 3″×5″ footprint with a uniform array of wells and a skirt extending around the perimeter of said multi-well plate;
(b) a compressed gasket extending over the upper surface of said multi-well plate sealing individual wells;
(c) a lid disposed on said compressed gasket providing a normal force compressing said gasket and securing said multi-well plate by means of side walls extending past the perimeter skirt of said multi-well plate and engaging the bottom of said skirt by means of multi-well plate holders; and
(d) a plurality of projections and apertures integral to said cover plate providing a means for mechanical manipulation of said cover and multi-well plate and stacking functionality of said cover and multiwell plate.
